(19) United States
(12) Patent Application Publication
(10) Pub. No.: US 2025/0264822 A1
(43) Pub. Date: Aug. 21, 2025

(54) RESIN PARTICLE, TONER, TONER CONTAINING UNIT, DEVELOPER, AND IMAGE FORMING APPARATUS

(71) Applicants: Toshihiko SUGIYAMA, Kanagawa (JP); Junichi WATANABE, Kanagawa (JP); Kenji KOMITO, Tokyo (JP); Shinya NAKAYAMA, Kanagawa (JP); Yuka MIZOGUCHI, Kanagawa (JP)

(72) Inventors: Toshihiko SUGIYAMA, Kanagawa (JP); Junichi WATANABE, Kanagawa (JP); Kenji KOMITO, Tokyo (JP); Shinya NAKAYAMA, Kanagawa (JP); Yuka MIZOGUCHI, Kanagawa (JP)

(21) Appl. No.: 19/043,579

(22) Filed: Feb. 3, 2025

(30) Foreign Application Priority Data
Feb. 15, 2024 (JP) 2024-020839
Sep. 30, 2024 (JP) 2024-171000

(51) Int. Cl. G03G 9/08; G03G 9/087; G03G 9/093

(52) U.S. Cl. CPC G03G 9/0825; G03G 9/08755; G03G 9/09328; G03G 9/09335; G03G 9/09371; G03G 9/09378

(57) ABSTRACT

A resin particle having a core-shell structure is provided that includes a binder resin and an organic compound having a sulfo group, in which Formula (1), I(100)<I(t)<I(0), and Formula (2), 0.005<I(100), are satisfied in a range of 0<t<100. I(t) represents, in a depth profile of a surface of the resin particle measured by time-of-flight secondary ion mass spectrometry, a secondary ion intensity derived from the sulfo group at t (nm) in depth from an outermost surface of the resin particle.

### CROSS-REFERENCE TO RELATED APPLICATIONS

This patent application is based on and claims priority pursuant to 35 U.S.C. § 119 (a) to Japanese Patent Application Nos. 2024-020839 and 2024-171000, filed on Feb. 15, 2024 and Sep. 30, 2024, respectively, in the Japan Patent Office, the entire disclosure of which is hereby incorporated by reference herein.

### BACKGROUND

### Technical Field

The present disclosure relates to a resin particle, a toner, a toner containing unit, a developer, and an image forming apparatus.

### Related Art

In recent years, with regard to toners, from the viewpoint of reductions in the load on the environment, recycled toners have been studied, in which a plant-derived resin or recovered polyethylene terephthalate is introduced as a binder resin.

Recycled toners superior in both charge stability and low-temperature fixability are desired because of a demand for high speed in these days.

### SUMMARY

Embodiments of the present invention provides a resin particle having a core-shell structure that includes a binder resin and an organic compound having a sulfo group, in which the following formulas (1) and (2) are satisfied in a range of 0<t<100:

$$I ( 100 ) < I ( t ) < I ( 0 ) \qquad Formula ( 1 )$$

$$0.005 < I ( 100 ) \qquad Formula ( 2 )$$

where I(t) represents, in a depth profile of a surface of the resin particle measured by time-of-flight secondary ion mass spectrometry, a secondary ion intensity derived from the sulfo group at t (nm) in depth from an outermost surface of the resin particle.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an image forming apparatus according to an embodiment of the present invention; and

FIG. 2 is a schematic view of a process cartridge according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

As techniques relating to various additives for improving the chargeability, durability, and preservability of toners all together, some types of toners are known, such as a toner in which the structure of a charge controlling agent and the amount of the charge controlling agent present in a toner base are defined, a toner in which a constituent unit of a monomer containing either a sulfonic acid group or a sulfonate group is defined, and a toner in which the surface acid value of a resin is defined to control adhesion to the surface of a polyester resin as a dispersion stabilizer on the surface of a base, and some effects are obtained.

However, further improvement in the performance of recycled toners is desired and, in particular, a technique for more precise control of the structure of a binder resin is desired.

Excessive presence of an organic compound having a sulfo group (hereinafter, also referred to as a “sulfo component”), which affects the charge stability, increases the viscoelasticity, lowers the sharp melting property, and reduces the low-temperature fixability. Therefore, in order to achieve both charge stability and low-temperature fixability of the toner, it is desirable to arrange the sulfo component in the base at an appropriate gradient. According to the present disclosure, both charge stability and low-temperature fixability are achieved by appropriately laminating the sulfo component.

According to a related art, the sulfo-derived shell is uniform, and it is difficult to control the arrangement of the sulfo component in the resin particle.

It is desirable that the largest amount of the sulfo component is present at the outermost surface of the core and the sulfo component is laminated such that the sulfo component gradually decreases from the outermost surface toward the inside with a certain gradient.

The charge stability is lowered when the amount of the sulfo component present in a depth of 100 nm from the outermost surface of the core is too small as compared with that at the outermost surface of the core, or when the amount of the sulfo component present in a depth of 100 nm from the outermost surface of the core is larger than the amount of the sulfo component present in a depth of 20 nm.

According to embodiments of the present invention, a resin particle is provided that solves the above-described various issues in the related art and provides a toner having a small environmental load and desirable charge stability and low-temperature fixability.

### Resin Particle

A resin particle according to embodiments of the present invention includes a base particle including a binder resin and an organic compound having a sulfo group.

The resin particle satisfies the following formulas (1) and (2) in a range of 0<t<100, where I(t) represents, in a depth profile of a surface of the resin particle measured by time-of-flight secondary ion mass spectrometry, a secondary ion intensity derived from the sulfo group at t (nm) in depth from an outermost surface of the resin particle.

$$I ( 100 ) < I ( t ) < I ( 0 ) \qquad Formula ( 1 )$$

$$0.005 < I ( 100 ) \qquad Formula ( 2 )$$

The above formula (1) means that the largest amount of the sulfo component is present at the outermost surface of the resin particle, and the above formula (2) means that a certain amount or more of the sulfo component is also present in a region close to the center away from the surface of the resin particle.

The resin particle according to embodiments of the present invention has a core-shell structure in which a shell layer adheres to the surface of a core layer. In this case, an emulsion aggregation method is most suitable as a method for producing resin particles in which a sulfo component-derived shell is laminated on the surface of the core with an arbitrary gradient. This is because it is easy to control the lamination gradient in the shell coating, such as the compatibility parameter between the core and the shell and the aggregation and fusion temperature.

Hereinafter, the “resin particle” may be referred to as “resin particles,” “toner” or “toner particles.” The “resin particle” may refer to a plurality of resin particles.

Examples of the organic compound having a sulfo group include, but are not limited to, sulfonic acid group-containing copolymers. Vinyl aromatic hydrocarbons used in producing sulfonic acid group-containing copolymers are compounds (monomers) having a structure in which a vinyl group is bonded to an aromatic hydrocarbon, and examples thereof include, but are not limited to, styrene, α-methylstyrene, 2-methylstyrene, 3-methylstyrene, 4-methylstyrene, 2-ethylstyrene, 3-ethylstyrene, 4-ethylstyrene, 2-propylstyrene, 3-propylstyrene, 4-propylstyrene, 2-isopropylstyrene, 3-isopropylstyrene, 4-isopropylstyrene, 2-chlorostyrene, 3-chlorostyrene, 4-chlorostyrene, 2-methyl-α-methylstyrene, 3-methyl-α-methylstyrene, 4-methyl-α-methylstyrene, 2-ethyl-α-methylstyrene, 3-ethyl-α-methylstyrene, 4-ethyl-α-methylstyrene, 2-propyl-α-methylstyrene, 3-propyl-α-methylstyrene, 4-propyl-α-methylstyrene, 2-isopropyl-α-methylstyrene, 3-isopropyl-α-methylstyrene, 4-isopropyl-α-methylstyrene, 2-chloro-α-methylstyrene, 3-chloro-α-methylstyrene, 4-chloro-α-methylstyrene, 2,3-dimethylstyrene, 3,4-dimethylstyrene, 2,4-dimethylstyrene, 2,6-dimethylstyrene, 2,3-diethylstyrene, 3,4-diethylstyrene, 2,4-diethylstyrene, 2,6-diethylstyrene, 2-methyl-3-ethylstyrene, 2-methyl-4-ethylstyrene, 2-chloro-4-methylstyrene, 2,3-dimethyl-α-methylstyrene, 3,4-dimethyl-α-methylstyrene, 2,4-dimethyl-α-methylstyrene, 2,6-dimethyl-α-methylstyrene, 2,3-diethyl-α-methylstyrene, 3,4-diethyl-α-methylstyrene, 2,4-diethyl-α-methylstyrene, 2,6-diethyl-α-methylstyrene, 2-ethyl-3-methyl-α-methylstyrene, 2-methyl-4-propyl-α-methylstyrene, and 2-chloro-4-ethyl-α-methylstyrene. These vinyl aromatic hydrocarbons may be used alone, or two or more of the vinyl aromatic hydrocarbons may be used in combination.

### Core-Shell Structure

The resin particle has a core-shell structure including a core layer and a shell layer. The shell resin forming the shell layer is preferably an amorphous polyester resin A described below, and an amorphous polyester resin contained in the core layer is preferably an amorphous polyester resin B described below. Preferably, the shell layer contains an organic compound having a sulfo group.

### Amorphous Polyester Resin A

The amorphous polyester resin A is preferably a linear polyester resin and is also preferably an unmodified polyester resin. The amorphous polyester resin A is a polyester resin soluble in tetrahydrofuran (THF) and chloroform.

The unmodified polyester resin is a polyester resin that is obtained by using a polyol and a polycarboxylic acid or its derivative and that is unmodified with an isocyanate compound or the like.

### Amorphous Polyester Resin B

The amorphous polyester resin B is preferably a linear polyester resin and is also preferably an unmodified polyester resin. The amorphous polyester resin B is a polyester resin soluble in THF and chloroform.

The amorphous polyester resin B preferably has neither a urethane bond nor a urea bond. By using plant-derived components or recycled-resin-derived components in at least any one of the polyol, the polycarboxylic acid, or the derivative thereof, the amorphous polyester resin B can be used as environment-responsive component.

### Method for Producing Resin Particles

The resin particles according to embodiments the present invention can be produced, for example, by the following production method.
a. Oil phase preparation process: process of preparing an oil phase in which a binder resin, a colorant, a crosslinking component, a wax, and the like, are dissolved or dispersed in an organic solvent.
b. Phase inversion emulsification process: process of adding water to the oil phase to cause phase inversion from a water-in-oil dispersion liquid to an oil-in-water dispersion liquid.
c. Solvent removal process: process of removing the organic solvent from the oil-in-water dispersion liquid to obtain a fine particle dispersion liquid.
d. Aggregation process: process of aggregating the fine particles of the fine particle dispersion liquid to obtain aggregated particles.
e: Process of forming a shell on a surface of the aggregated particle.
f: Process of fusing the aggregated particles forming the shell.
g: Process of annealing the fused aggregated particles, when needed.
h: Process of washing and drying the particles.

Each of the above-described processes and the materials used in each of the processes will be described below.

### Oil Phase Preparation Process

First, an oil phase is prepared by dissolving or dispersing a binder resin, a colorant, a crosslinking component, a wax, and the like, in an organic solvent. The oil phase may be prepared by gradually adding and dissolving or dispersing a binder resin, a colorant, and the like, in an organic solvent while stirring. A known dispersing machine can be used for dispersion, and for example, a dispersing machine such as a bead mill or a disk mill can be used.

The materials used in the oil phase preparation process will be described below.

### Binder Resin

Examples of the binder resin include the amorphous polyester resin B. The amorphous polyester resin B is preferably an amorphous polyester resin that is advantageous for low-temperature fixing, in particular, preferably a linear polyester resin, and also preferably an unmodified polyester resin.

The unmodified polyester resin is a polyester resin obtained by using a polyol and a polycarboxylic acid or its derivative (e.g., polycarboxylic acid anhydride, polycarboxylic acid ester) and that is unmodified with an isocyanate compound or the like.

The amorphous polyester resin preferably has neither a urethane bond nor a urea bond. Preferably, the amorphous polyester resin includes dicarboxylic acid components as constituents, which include terephthalic acid in an amount of 50% by mol or more. This configuration is advantageous in terms of heat-resistant preservability.

As the amorphous polyester resin used in the present disclosure, a biomass-derived resin synthesized using a plant-derived monomer is preferably used.

Propylene glycol is preferably used as the plant-derived alcohol monomer, and terephthalic acid or succinic acid is preferably used as the acid component.

There is no particular limitation, and any plant-derived component may be used.

According to embodiments of the present invention, a recycle-derived resin is preferably used as the binder resin.

For the recycle-derived resin used in the present disclosure, polyethylene terephthalate (PET) and polybutylene terephthalate (PBT), which are one of the raw materials, are obtained by processing a recycled product in a flake form and have a weight-average molecular weight (Mw) of about 30,000 to 100,000, but are not limited by the molecular weight distribution, composition, production method, form when used, and the like, of PET and PBT. Further, PET and PBT are not limited to recycled products, and off-specification fiber waste or pellets may be used. By adjusting the ratio at which the recycled PET is introduced during the synthesis of the polyester resin, it is possible to adjust the environment-responsive ratio and the toner quality.

Examples of the polyol include, but are not limited to, diols.

Examples of the diols include, but are not limited to: alkylene (C2-C3) oxide adducts of bisphenol A with an average addition molar number of 1 to 10, such as polyoxypropylene (2.2)-2,2-bis(4-hydroxyphenyl) propane and polyoxyethylene (2.2)-2,2-bis(4-hydroxyphenyl) propane; ethylene glycol and propylene glycol; and hydrogenated bisphenol A and alkylene (C2-C3) oxide adducts of hydrogenated bisphenol A with an average addition molar number of 1 to 10.

Each of the above can be used alone, or two or more of the above may be used in combination.

Examples of the polycarboxylic acid include, but are not limited to, dicarboxylic acids.

Examples of the dicarboxylic acids include, but are not limited to: adipic acid, phthalic acid, isophthalic acid, terephthalic acid, fumaric acid, and maleic acid; and succinic acid derivatives substituted with an alkyl group having 1 to 20 carbon atoms or an alkenyl group having 2 to 20 carbon atoms, such as dodecenyl succinic acid and octyl succinic acid.

In particular, a plant-derived saturated aliphatic succinic acid is preferably included.

Carbon neutrality can be enhanced by being derived from a plant. The saturated aliphatic group has an effect of increasing the recrystallization property of the crystalline polyester resin and can increase the aspect ratio of the crystalline polyester resin and improve the low-temperature fixability. Each of the above can be used alone, or two or more of the above may be used in combination.

The amorphous polyester resin B may include at least any one of the trivalent or higher carboxylic acid or the trivalent or higher alcohol at a terminal of the resin chain, for the purpose of adjusting acid value and hydroxyl group.

Examples of the trivalent or higher carboxylic acid include, but are not limited to, trimellitic acid, pyromellitic acid, and acid anhydrides thereof.

Examples of the trivalent or higher alcohol include, but are not limited to, glycerin, pentaerythritol, and trimethylolpropane.

The molecular weight of the amorphous polyester resin B is not particularly limited and can be suitably selected to suit to a particular application. In gel permeation chromatography (GPC) measurement, the weight-average molecular weight (Mw) is preferably 3,000 or more and 10,000 or less. The number average molecular weight (Mn) is preferably 1,000 or more and 4,000 or less. The ratio Mw/Mn is preferably from 1.0 to 4.0.

When the molecular weight is equal to or more than the lower limit value, it is possible to suppress a decrease in the heat-resistant preservability of the toner and the durability against stress such as stirring in a developing machine.

When the molecular weight is equal to or less than the upper limit value, it is possible to suppress an increase in viscoelasticity of the toner at the time of melting and to suppress a decrease in low-temperature fixability.

The weight-average molecular weight (Mw) is more preferably 4,000 or more and 7,000 or less. The number average molecular weight (Mn) is more preferably 1,500 or more and 3,000 or less. The ratio Mw/Mn is more preferably 1.0 or more and 3.5 or less.

The acid value of the amorphous polyester resin B is not particularly limited and can be suitably selected to suit to a particular application. 1 mgKOH/g or more and 50 mgKOH/g or less is preferable, and 5 mgKOH/g or more and 30 mgKOH/g or less is more preferable. When the acid value is 1 mgKOH/g or more, the toner may become more negatively-chargeable and more compatible with paper when being fixed thereon, and low-temperature fixability may be improved. When the acid value is 50 mgKOH/g or less, it is possible to suppress a decrease in charge stability, particularly charge stability against environmental fluctuations.

The hydroxyl value of the amorphous polyester resin B is not particularly limited and can be suitably selected to suit to a particular application, but preferably is 5 mgKOH/g or more.

The amorphous polyester resin B preferably has a glass transition temperature (Tg) of 40° C. or more and 80° C. or less, more preferably 50° C. or more and 70° C. or less. When the glass transition temperature is 40° C. or more, the heat-resistant preservability of the toner and the durability against stress such as stirring in a developing device are sufficient, and also filming resistance is desirable. When the glass transition temperature is 80° C. or less, the toner sufficiently deforms when fixed by application of heat and pressure, and low-temperature fixability is desirable.

The molecular structure of the amorphous polyester resin B can be determined by, for example, solution or solid nuclear magnetic resonance (NMR), X-ray diffractometry, gas chromatography mass spectroscopy (GC-MS), liquid chromatography mass spectroscopy (LC-MS1), or infrared spectroscopy (IR). Simple examples of the method include, but are not limited to, detecting an amorphous polyester resin as a substance having no absorption based on δCH (out-of-plane bending vibration) of olefin at 965±10 cm⁻¹ and 990±10 cm⁻¹ in an infrared absorption spectrum.

The content of the amorphous polyester resin B is not particularly limited and can be suitably selected to suit to a particular application. The content in 100 parts by mass of the toner is preferably 50 parts by mass or more and 90 parts by mass or less, and more preferably 60 parts by mass or more and 80 parts by mass or less. When the content is 50 parts by mass or more, the dispersibility of the pigment and the releasing agent in the toner can be prevented from deteriorating, and the occurrence of fogging and disturbance of an image can be prevented. When the content is 90 parts by mass or less, it is possible to prevent the contents of the crystalline polyester resin C and the amorphous polyester resin A from decreasing, and to suppress a decrease in low-temperature fixability. When the content falls within the preferred range, image quality and low-temperature fixability are all desirable.

### Shell Resin

The shell resin is preferably the above-described amorphous polyester resin A, and desirably include no plant-derived resin. The amorphous polyester resin A may be an organic compound having a sulfo group. Examples of the polyol include, but are not limited to, diols. Examples of the diols include, but are not limited to: alkylene (C2-C3) oxide adducts of bisphenol A with an average addition molar number of 1 to 10, such as polyoxypropylene (2.2)-2,2-bis(4-hydroxyphenyl) propane and polyoxyethylene (2.2)-2,2-bis(4-hydroxyphenyl) propane; and hydrogenated bisphenol A and alkylene (C2-C3) oxide adducts of hydrogenated bisphenol A with an average addition molar number of 1 to 10.

Each of the above can be used alone, or two or more of the above may be used in combination. Examples of the polycarboxylic acid include, but are not limited to, dicarboxylic acids such as adipic acid, phthalic acid, isophthalic acid, terephthalic acid, fumaric acid, and maleic acid.

Examples of sulfo-group-containing components include, but are not limited to, sodium 5-sulfoisophthalate.

### Crystalline Resin

A crystalline resin is preferably added to the toner according to embodiments of the present invention in order to improve the low-temperature fixability. The crystalline resin may be added to either of the core layer and the shell layer and is preferably added to the core layer.

The crystalline resin is not particularly limited and can be suitably selected to suit to a particular application as long as the crystalline resin has crystallinity. Examples thereof include, but are not limited to, polyester resin, polyurethane resin, polyurea resin, polyamide resin, polyether resin, vinyl resin, and modified crystalline resin. Each of the above can be used alone, or two or more of the above may be used in combination. The crystalline polyester will be described below.

### Crystalline Polyester Resin

The crystalline polyester resin is obtained from a polyol and a polycarboxylic acid or derivative thereof, such as a polycarboxylic acid anhydride and a polycarboxylic acid ester. According to embodiments of the present invention, the crystalline polyester resin refers to a resin obtained by using a polyol and a polycarboxylic acid or its derivative (e.g., polycarboxylic acid anhydride, polycarboxylic acid ester), as described above. Modified polyester resins, such as prepolymers and resins obtained by cross-linking and/or elongating the prepolymers, do not belong to the crystalline polyester resin.

### Polyol

The polyol is not particularly limited and can be suitably selected to suit to a particular application. Examples of the polyol include, but are not limited to, diols and trivalent or higher alcohols.

Examples of the diols include, but are not limited to, saturated aliphatic diols. Examples of the saturated aliphatic diols include, but are not limited to, straight-chain saturated aliphatic diols and branched saturated aliphatic diols. In particular, straight-chain saturated aliphatic diols are preferable, and straight-chain saturated aliphatic diols having 2 to 12 carbon atoms are more preferable. The branched saturated aliphatic diols may reduce crystallinity of the crystalline polyester resin and reduce the melting point thereof. Saturated aliphatic diols having more than 12 carbon atoms cause unavailability of materials in practice.

Examples of the saturated aliphatic diols include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanediol. In particular, ethylene glycol, 1,4-butanediol, 1,6-hexanediol, 1,8-octanediol, 1,9-nonanediol, 1,10-decanediol, and 1,12-dodecanediol are preferred for obtaining a crystalline polyester resin having high crystallinity and sharp melting property.

Examples of the trivalent or higher alcohols include, but are not limited to, glycerin, trimethylolethane, trimethylolpropane, and pentaerythritol. Each of the above may be used alone, or two or more of the above may be used in combination.

### Polycarboxylic Acid

The polycarboxylic acid is not particularly limited and can be suitably selected to suit to a particular application. Examples of the polycarboxylic acid include, but are not limited to, divalent carboxylic acids and trivalent or higher carboxylic acids. Examples of the dicarboxylic acid include, but are not limited to, saturated aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; and aromatic dicarboxylic acids, such as phthalic acid, isophthalic acid, terephthalic acid, naphthalene-2,6-dicarboxylic acid, malonic acid, and mesaconic acid. In addition, anhydrides thereof and lower alkyl esters (1 to 3 carbon atoms) thereof are also included.

In particular, from the viewpoint of carbon neutrality, a plant-derived saturated aliphatic compound having 12 or less carbon atoms is preferable.

Examples of the trivalent or higher carboxylic acids include, but are not limited to, 1,2,4-benzenetricarboxylic acid, 1,2,5-benzenetricarboxylic acid, 1,2,4-naphthalenetricarboxylic acid, and anhydrides and lower alkyl esters (C₁-C₃) thereof. Each of the above may be used alone, or two or more of the above may be used in combination.

The crystalline polyester resin preferably includes a straight-chain saturated aliphatic dicarboxylic acid having 4 to 12 carbon atoms and a straight-chain saturated aliphatic diol having 2 to 12 carbon atoms. Thus, high crystallinity and desirable sharp melting property may achieve desirable low-temperature fixability. The crystallinity and softening point of the crystalline polyester resin can be controlled by designing and using a non-linear polyester prepared by a polycondensation between alcohol components including a polyol having 3 or more valences, such as glycerin, and acid components including a polycarboxylic acid having 3 or more valences, such as trimellitic anhydride, when synthesizing the polyester.

The molecular structure of the crystalline polyester resin according to embodiments of the present invention can be determined by solution or solid NMR measurement, X-ray diffraction, GC-MS, LC-MS, IR measurement, or the like, and simple examples thereof include, but are not limited to, a substance having absorption based on δCH (out-of-plane bending vibration) of olefin at 965±10 cm⁻¹ and 990±10 cm⁻¹ in an infrared absorption spectrum.

As the molecular weight distribution becomes sharper and the molecular weight becomes lower, the low-temperature fixability improves. As the number of low-molecular-weight components increases, the heat-resistant preservability deteriorates. Thus, as a result of an intensive study on the molecular weight, it is preferable that a molecular weight distribution chart with log (M) on the horizontal axis and % by weight on the vertical axis with respect to o-dichlorobenzene soluble components by GPC has a peak position within a range of from 3.5 to 4.0, the peak has a half value width of 1.5 or less, the weight-average molecular weight (Mw) is from 3,000 to 30,000, the number average molecular weight (Mn) is from 1,000 to 10,000, and the ratio Mw/Mn is from 1 to 10.

More preferably, the weight-average molecular weight (Mw) is from 5,000 to 15,000, the number average molecular weight (Mn) is from 2,000 to 10,000, and the ratio Mw/Mn is from 1 to 5.

From the viewpoint of affinity between paper and resins, the acid number of the crystalline polyester resin is preferably 5 mgKOH/g or more in order to achieve the intended low-temperature fixability, more preferably 7 mgKOH/g or more in order to produce fine particles by a phase inversion emulsification method, and on the other hand, preferably 45 mgKOH/g or less in order to improve the hot offset resistance. The hydroxyl value of the crystalline polymer is preferably 0 mgKOH/g or more and 50 mgKOH/g or less, and more preferably 5 mgKOH/g or more and 50 mgKOH/g or less, in order to achieve predetermined low-temperature fixability and desirable charge property.

### Colorant

Examples of the colorant include, but are not limited to, known dyes and pigments such as carbon black, nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarin Lake, Thioindigo Red B, Thioindigo Maroon, Oil Red, Quinacridone Red, Pyrazolone Red, polyazo red, Chrome Vermilion, Benzidine Orange, Perinone Orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and combinations thereof.

### Organic Solvent

The organic solvents are preferably volatile and have a boiling point lower than 100° C. because the organic solvents can be easily removed later. Examples of such organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, methanol, ethanol, and isopropyl alcohol. These solvents can be used alone, or two or more of these solvents may be used in combination. In a case where a resin to be dissolved or dispersed in an organic solvent has a polyester skeleton, the organic solvent is preferably selected from an ester solvent (e.g., methyl acetate, ethyl acetate, or butyl acetate) or a ketone solvent (e.g., methyl ethyl ketone, or methyl isobutyl ketone), which has high solubility. In particular, methyl acetate, ethyl acetate, and methyl ethyl ketone are preferable for their high removability.

A charge controlling agent or the like may be added to the oil phase.

### Charge Controlling Agent

Known charge controlling agents may be used. Examples of the charge controlling agents include, but are not limited to, nigrosine dyes, triphenylmethane dyes, chromium-containing metal complex dyes, chelate pigments of molybdic acid, Rhodamine dyes, alkoxyamines, quaternary ammonium salts (including fluorine-modified quaternary ammonium salts), alkylamides, phosphor and phosphor-containing compounds, tungsten and tungsten-containing compounds, fluorine activators, metal salts of salicylic acid, and metal salts of salicylic acid derivatives. Examples of commercially available charge controlling agents include, but are not limited to, BONTRON® 03 (nigrosine dye), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complexes of quaternary ammonium salts), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGE® NX VP434 (quaternary ammonium salts), which are manufactured by Hoechst AG; LRA-901 and LR-147 (boron complex), which are manufactured by Japan Carlit Co., Ltd.; and copper phthalocyanine, perylene, quinacridone, azo pigments, and polymers having a functional group such as a sulfonate group, a carboxyl group, and a quaternary ammonium group. The amount of the charge controlling agent is determined so that the charge controlling agent exerts its function without inhibiting fixing property. The charge controlling agent preferably accounts for 0.5% to 5% by mass, preferably 0.8% to 3% by mass, of the toner.

### Wax

The wax is not particularly limited and can be suitably selected to suit to a particular application, but releasing agents having a low melting point of from 50° C. to 120° C. are preferred. A releasing agent having a low melting point, when dispersed in the resin, works effectively between a fixing roller and the toner, whereby hot offset resistance is improved even in an oilless system (in which a fixing roller is not applied with any releasing agent such as oil).

Preferred examples of the releasing agent include, but are not limited to, waxes. Examples of the waxes include, but are not limited to, natural waxes such as plant waxes (e.g., carnauba wax, cotton wax, sumac wax, rice wax), animal waxes (e.g., bees wax, lanolin), mineral waxes (e.g., ozokerite, ceresin), and petroleum waxes (e.g., paraffin wax, microcrystalline wax, petrolatum wax). In addition to these natural waxes, synthetic hydrocarbon waxes (e.g., Fischer-Tropsch wax, polyethylene wax) and synthetic waxes (e.g., ester, ketone, ether) may also be used. Furthermore, the following materials may also be used: fatty acid amides such as 12-hydroxystearic acid amide, stearic acid amide, phthalic anhydride imide, and chlorinated hydrocarbon; homopolymers and copolymers of polyacrylates (e.g., poly-n-stearyl methacrylate, poly-n-lauryl methacrylate), which are low-molecular-weight crystalline polymers, such as copolymer of n-stearyl acrylate and ethyl methacrylate; and crystalline polymers having a long alkyl group on a side chain. Each of the above can be used alone, two or more of the above may be used in combination.

From the viewpoint of carbon neutral, plant waxes are preferable.

The melting point of the wax is not particularly limited and can be suitably selected to suit to a particular application, but is preferably from 50° C. to 120° C., more preferably from 60° C. to 90° C. When the melting point is 50° C. or more, it is possible to prevent the wax from adversely affecting heat-resistant preservability, and when the melting point is 120° C. or less, it is possible to effectively prevent a problem that cold offset occurs at the time of fixing at a low temperature. The wax preferably has a melt viscosity of 5 cps to 1,000 cps, more preferably of 10 cps to 100 cps, when measured at a temperature 20° C. higher than the melting point thereof. When the melt viscosity is 5 cps or more, a decrease in releasability can be prevented, and when the melt viscosity is 1,000 cps or less, the effects of hot offset resistance and low-temperature fixability can be sufficiently exhibited. The content of the wax in the toner is not particularly limited and can be suitably selected to suit to a particular application, but is preferably from 0% by mass to 40% by mass, and more preferably from 3% by mass to 30% by mass. When the content is 40% by mass or less, deterioration of the fluidity of the toner can be prevented.

### Phase Inversion Emulsification Process

Next, the oil phase obtained in the oil phase preparation process is subjected to phase inversion emulsification.

According to embodiments of the present invention, after the oil phase is neutralized with an alkali such as sodium hydroxide or aqueous ammonia, ion-exchange water is added thereto to cause phase inversion emulsification from a water-in-oil dispersion liquid to an oil-in-water dispersion liquid.

### Solvent Removal Process

In order to remove the organic solvent from the obtained oil-in-water dispersion liquid, a method can be employed in which the temperature is gradually raised while stirring the entire system to completely evaporate and remove the organic solvent in the liquid droplets.

Alternatively, it is also possible that the obtained oil-in-water dispersion liquid is sprayed into dry atmosphere while being stirred so that the organic solvent is completely removed from the liquid droplets. Alternatively, the organic solvent may be removed by evaporation by reducing the pressure while stirring the oil-in-water dispersion liquid. The latter two methods can be combined with the first method.

Examples of the dry atmosphere into which the oil-in-water dispersion liquid is sprayed include, but are not limited to, heated gaseous matter such as air, nitrogen, carbon dioxide gas, or combustion gas. In particular, various gases heated to above the maximum boiling point among the used solvents are generally used. A desired quality can be sufficiently obtained by a belt drier, a rotary kiln, or the like, within a short period of time.

By the above method, a fine particle dispersion can be obtained.

### Aggregation Process

Next, the obtained fine particle dispersion is aggregated while stirring until an arbitrary particle diameter is obtained. For the aggregation, an existing method such as addition of an aggregating agent or pH adjustment can be used. In the case of adding an aggregating agent, the aggregating agent may be added as it is, but an aqueous solution of the aggregating agent is preferably used because a local increase in concentration can be avoided.

Further, it is preferable to gradually add an aggregating agent while observing the particle diameter of the aggregated particles.

The temperature of the dispersion liquid at the time of aggregation is preferably around the Tg of the resin used. When the liquid temperature is too low, the efficiency is poor because the aggregation does not proceed so much, and when the liquid temperature is too high, the aggregation rate is increased, and the particle diameter distribution is deteriorated, for example, coarse particles are generated.

When the target particle diameter is reached, the aggregation is stopped. Examples of the method for stopping the aggregation include, but are not limited to, a method of adding a salt having a low ionic valence or a chelating agent, a method of adjusting pH, a method of lowering the temperature of the dispersion liquid, and a method of adding a large amount of an aqueous solvent to dilute the concentration.

By the above method, a dispersion liquid of aggregated particles can be obtained.

In the aggregation process, a wax may be added as a releasing agent, or a crystalline resin may be added for low-temperature fixability. In this case, aggregated particles in which the wax or the crystalline resin is uniformly dispersed can be obtained by preparing a dispersion liquid in which the wax is dispersed in an aqueous solvent or a dispersion liquid of the crystalline resin in the same manner, mixing the dispersion liquid with the fine particle dispersion liquid, and aggregating the mixture.

The aggregating agent will be described below.

### Aggregating Agent

Known aggregating agents can be used as the aggregating agent. Example of usable aggregating agents include, but are not limited to, a metal salt of a monovalent metal such as sodium and potassium, a metal salt of a divalent metal such as calcium and magnesium, or a metal salt of a trivalent metal such as iron and aluminum.

### Shell Forming Process

A shell forming process is a process of forming a shell layer on the aggregated particles obtained in the aggregation process.

A method of forming the shell layer is not limited and can be selected to suit to a particular application. Examples thereof include, but are not limited to, a method in which the shell resin is added after the fusion process in which spherical particles having a target particle diameter is prepared, then the aggregation process and the fusion process are repeated.

### Fusion Process

Next, the aggregated particles thus obtained are fused by a heat treatment to reduce unevenness and are formed into a spherical shape. The fusion may be performed by heating the dispersion liquid of the colored aggregated particles while stirring. The temperature of the liquid is preferably around a temperature exceeding the Tg of the resin used.

### Washing and Drying Process

Since the toner particle dispersion liquid obtained by the above-described method includes a sub material such as an aggregated salt in addition to the toner particles, washing is performed to take out the toner particles from the dispersion liquid.

The method for washing the toner particles include, but are not limited to, centrifugal separation, reduced pressure filtration, and filter press.

In either method, a cake of toner particles is obtained. When washing is insufficient in one operation, it is possible to redisperse the obtained cake in an aqueous solvent to prepare a slurry and repeat any of the above methods. In the case where the washing is performed by reduced pressure filtration or filter press, it is possible to let an aqueous solvent pass through the cake to wash the sub material away from the colored resin particles.

As the aqueous solvent used in the washing, water, or a mixed solvent of water with an alcohol (e.g., methanol, ethanol) is used. In view of cost and environmental load caused by effluent treatment, water is preferable.

After the washing process, the toner particles contain a large amount of aqueous solvent. Therefore, the toner particles are isolated by removing the aqueous solvent therefrom by drying.

The drying can be performed by means of spray dryer, vacuum freeze dryer, reduced pressure dryer, standstill shelf dryer, movable shelf dryer, fluidized bed dryer, rotary dryer, stirring dryer, or the like. It is preferable that the toner particles are subjected to the drying until the residual moisture becomes less than 1%.

In a case where the dried colored resin particles are in the form of soft aggregate to cause an inconvenience in use, the soft aggregate may be loosened by means of jet mill, HENSCHEL MIXER, SUPER MIXER, coffee mill, OSTER BLENDER, food processor, or the like.

### Annealing Process

In a particular case where a crystalline resin is added, performing an annealing treatment after the fusion makes the amorphous resin and the crystalline resin phase-separated, thus enhancing the fixability. Specifically, such an annealing treatment may be a preservation at a temperature around Tg for 10 hours or more.

### External Addition Process

Inorganic fine particles, fine polymeric particles, a cleaning aid, and the like, may be added to and mixed with the toner particles obtained according to embodiments of the present invention in order to impart fluidity, chargeability, cleanability, and the like.

Specific examples of the mixing method include, but are not limited to, applying an impulsive force to a mixture from blades rotating at a high speed, and putting and accelerating the mixture in a high-speed airflow so that the particles collide with each other or the combined particles collide with an appropriate collision plate. Such a treatment can be performed by ONG MILL (from Hosokawa Micron Co., Ltd.), a modified I-TYPE MILL such that the pulverizing air pressure is reduced (from Nippon Pneumatic Mfg. Co., Ltd.), HYBRIDIZATION SYSTEM (from Nara Machine Co., Ltd.), KRYPTON SYSTEM (from Kawasaki Heavy Industries, Ltd.), or an automatic mortar.

### External Additive

The primary particle diameter of the inorganic fine particles is preferably 5 nm or more and 2 μm or less, particularly preferably 5 nm or more and 500 nm or less. The specific surface area by the Brunauer-Emmett-Teller (BET) method is preferably 20 m²/g or more and 500 m²/g or less. The use ratio of the inorganic fine particles is preferably 0.01% by mass or more and 5% by mass or less of the toner.

Specific examples of the fine inorganic particles include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

Specific examples of the fine polymeric particles include, but are not limited to, polystyrene particles obtained by soap-free emulsion polymerization, suspension polymerization, or dispersion polymerization; particles of copolymer of methacrylates and/or acrylates; particles of polycondensation polymer such as silicone, benzoguanamine, and nylon; and thermosetting resin particles.

The fluidizer may be surface-treated to improve its hydrophobicity to prevent deterioration of fluidity and chargeability even under high-humidity conditions. Examples of the surface treatment agent include, but are not limited to, silane coupling agents, silylation agents, silane coupling agents having a fluorinated alkyl group, organic titanate coupling agents, aluminum coupling agents, silicone oils, and modified silicone oils.

Examples of the cleanability improver for removing the developer remaining on the photoconductor or the primary transfer medium after the transfer include, but are not limited to, fatty acid metal salts such as zinc stearate, calcium stearate, and stearic acid, and fine polymer particles produced by soap-free emulsion polymerization such as fine polymethyl methacrylate particles and fine polystyrene particles. Preferably, the particle size distribution of the fine polymer particles is relatively narrow, and the volume average particle diameter thereof is in the range of from 0.01 to 1 μm.

### Measurement Method

The “depth profile measurement of the resin particle surface by time-of-flight secondary ion mass spectrometry” according to embodiments of the present invention is defined as the following measurement.

### Depth Profile Evaluation

For the pelletized resin particles, a negative ion depth profile was measured under the following conditions using a time-of-flight secondary ion mass spectrometer (abbreviated as ToF-SIMS: model name: TOF-SIMS IV manufactured by ION-TOF Corporation).
Primary ion: Bi³⁺⁺, acceleration voltage: 30 kV, irradiation current: 0.2 pA, 150 μm for four-way scanning
Secondary ion: negative ion collection, 4 scan/cycle integration
Sputter: Ar+, acceleration voltage: 2 kV, irradiation current: 50 nA, 40 sec/cycle SO₃⁽⁻⁾ secondary ion intensity I(t) at a sputtering time of t seconds was determined.

The sputtering rate is calculated using a standard sample.

As for the relationship between the sputtering time and the depth, 30 nm cutting can be performed at 100 s in a polymethyl methacrylate (PMMA) film.

From the sputtering rate, the sputtering time on the horizontal axis of the depth profile is converted into the depth.

Separation of Toner Base Particles from Toner

The above-described measurement can also be performed using the toner base particles obtained by eliminating an additive from the toner as follows.

5.00 g of a surfactant and 300 mL of distilled water are added and dissolved in a 500 mL beaker. Then, the mixture is diluted to 1,000 mL to obtain a surfactant solution.

DRIWEL (manufactured by FUJIFILM Corporation) is used as the surfactant.

3.75 g of toner is added to and uniformly dispersed in 50 mL of the surfactant solution.

The toner dispersion liquid is irradiated with ultrasonic waves for 100 seconds using an ultrasonic homogenizer (product name: Homogenizer, Type: VCX750, CV33, manufactured by Sonics & Materials, Inc.) at a power of 40 W and a frequency of 20 kHz.

The amount of energy applied at this time is calculated from the product of the output and the irradiation time (40 W×100 seconds=4 kJ).

These treatments are conducted while appropriately cooling the toner dispersion liquid so that the liquid temperature thereof becomes 40° C. or more.

The obtained dispersion liquid is subjected to suction filtration with filter paper (product name: qualitative filter paper (No. 2, 110 mm), manufactured by Advantec Toyo Kaisha, Ltd.), washed twice with ion-exchange water again, subjected to filtration under reduced pressures to remove free additives, and then dried with a dryer for 1 hour or more to obtain toner base particles as a measurement sample.

This operation is performed a plurality of times to secure a desired amount.

### Developer Containing Unit

A developer containing unit according to embodiments of the present invention refers to a unit containing a developer in a unit having a function of containing a developer.

Examples of the developer containing unit include, but are not limited to, a developer container, a developing device, and a process cartridge.

The developer container refers to a container that contains the developer.

The developing device refers to a unit that contains the developer and develops images.

The process cartridge refers to a combined body of at least an image bearer with a developing unit, which is detachably attached to an image forming apparatus. At least one of a charge unit, an irradiation unit, or a cleaning unit may be integrated with the image bearer and the developing unit.

### Image Forming Apparatus

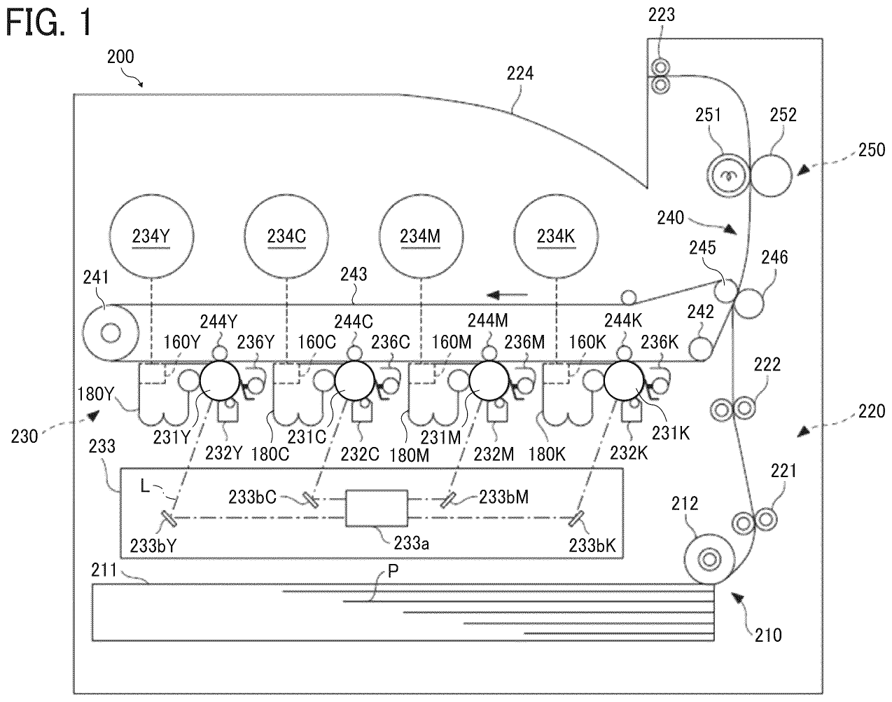

A method for forming an image by an image forming apparatus according to an embodiment of the present invention is described below with reference to FIG. 1. Although a printer is illustrated as an example of the image forming apparatus according to the present embodiment, the image forming apparatus is not particularly limited thereto as long as the image forming apparatus may form an image with toner, such as copiers, facsimile machines, and multifunction peripherals.

The image forming apparatus 200 includes a sheet feeding unit 210, a conveying unit 220, an image forming unit 230, a transfer unit 240, and a fixing unit 250.

The sheet feeding unit 210 includes a sheet tray 211 in which sheets P are stacked, and a feed roller 212 that feeds the sheets P stacked in the sheet tray 211 one by one.

The conveying unit 220 includes: a roller 221 that conveys the sheet P fed by the feed roller 212 toward the transfer unit 240; a pair of timing rollers 222 that holds the leading edge of the sheet P conveyed by the roller 221 and feeds the sheet P to the transfer unit 240 at a predetermined timing; and an output roller 223 that ejects the sheet P having a fixed color toner image to an output tray 224.

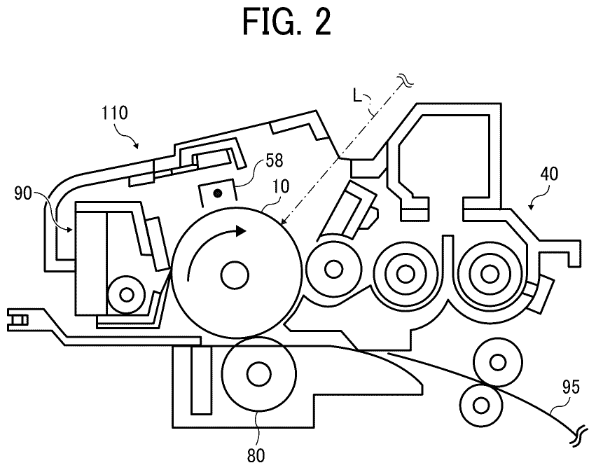

The image forming unit 230 includes: from left to right in FIG. 2 at predetermined intervals, an image forming unit 180Y that forms an image using a developer containing yellow toner, an image forming unit 180C that forms an image using a developer containing cyan toner, an image forming unit 180M that forms an image using a developer containing magenta toner, and an image forming unit 180K that forms an image using a developer containing black toner; chargers 232Y, 232C, 232M, and 232K; and an irradiator 233. The irradiator 233 includes a light source 233a and polygon mirrors 233bY, 233bC, 233bM, and 233bK. The image forming apparatus 200 further includes toner bottles 234Y, 234C, 234M, and 234K, sub hoppers 160Y, 160C, 160M, and 160K, and cleaners 236Y, 236C, 236M, and 236K.

Hereinafter, any of the image forming units Y, C, M, and K will be simply referred to as the image forming unit.

The developer contains a toner and a carrier. The four image forming units Y, C, M, and K have substantially the same mechanical configuration except that the developers contained therein are different.

The transfer unit 240 includes: a driving roller 241; a driven roller 242; an intermediate transfer belt 243 rotatable counterclockwise in FIG. 1 in accordance with driving of the driving roller 241; primary transfer rollers 244Y, 244C, 244M, and 244K disposed facing respective photoconductor drums 231Y, 231C, 231M, and 231K with the intermediate transfer belt 243 therebetween; and a secondary opposing roller 245 and a secondary transfer roller 246 disposed facing each other with the intermediate transfer belt 243 therebetween at a position where the toner image is transferred onto the sheet P.

The fixing unit 250 includes: a fixing belt 251 that contains a heater inside to heat the sheet P; and a pressure roller 252 rotatably pressed against the fixing belt 251 to form a nip therebetween. The color toner image on the sheet P is applied with heat and pressure, and the color toner image is fixed. The sheet P on which the color toner image has been fixed is ejected onto the output tray 224 by the output roller 223, and a series of image forming processes is completed.

### Process Cartridge

A process cartridge according to embodiments of the present invention includes an electrostatic latent image bearer to bear an electrostatic latent image and a developing unit to develop the electrostatic latent image into a toner image with the developer according to embodiments of the present invention. The process cartridge is configured to be detachably mountable on an image forming apparatus. The process cartridge may further include other members as appropriate.

The developing unit includes at least a developer container containing the developer according to embodiments of the present invention and a developer bearer to bear and convey the developer contained in the developer container. The developing unit may further include a regulator to regulate the thickness of the developer layer borne on the developer bearer.

FIG. 2 is a schematic view of a process cartridge according to embodiments of the present invention. A process cartridge 110 includes a photoconductor drum 10, a corona charger 58, a developing device 40, a transfer roller 80, and a cleaner 90. In FIG. 2, L denotes a laser light beam and 95 denotes a paper sheet P.

### Example

Hereinafter, the present invention will be further described with reference to examples, but the present invention is not limited to the following examples. In the following descriptions, “parts” and “%” represent “parts by mass” and “% by mass,” respectively.

### Production of Resin Particles 1 to 7

### Synthesis of Amorphous Polyester Resin

In a four-neck flask including a nitrogen introducing tube, a dewatering tube, a stirrer, and a thermocouple, alcohol components including ethylene oxide 2-mol adduct of bisphenol A (BisA-EO) and propylene oxide 2-mol adduct of bisphenol A (BisA-PO) at a molar ratio (BisA-EO/BisA-PO) of 60/40 and acid components including terephthalic acid and adipic acid at a molar ratio (terephthalic acid/adipic acid) of 97/3 were contained, such that the molar ratio (OH/COOH) of hydroxy groups to carboxyl groups became 1.3. After adding 500 ppm (based on the resin components) of titanium tetraisopropoxide to the flask, the flask contents were reacted at 230° C. at normal pressures for 8 hours, and subsequently at reduced pressures of 10 mmHg to 15 mmHg for 4 hours. After further adding 1% by mol (based on all the resin components) of trimellitic anhydride to the flask, the flask contents were reacted at 180° C. at normal pressures for 3 hours. Thus, an amorphous polyester resin 1 was prepared.

### Introduction of PET

The flaky recycled PET was mixed with the materials in the synthesis of the amorphous polyester resin described above so that the solid content of the recycled PET in 100 parts of the amorphous polyester resin 1 was the number of parts described in Table 2.

The numerical value of PET in Table 2 is the number of parts in 100 parts of the amorphous polyester resin.

### Preparation of Wax Dispersion Liquid

180 parts of an ester wax (WE-11, synthetic wax of a plant-derived monomer, melting point: 67° C., manufactured by NOF Corporation) and 17 parts of an anionic surfactant (NEOGEN SC, sodium dodecylbenzenesulfonate, manufactured by Dai-ichi Kogyo Seiyaku Co., Ltd.) as a surfactant were added to 720 parts of ion-exchange water. The mixture was subjected to a dispersion treatment with a homogenizer while heating to 90° C. to obtain a wax dispersion liquid 1.

### Preparation of Pigment Masterbatch

1,200 parts of water, 500 parts of carbon black (Printex® 35, manufactured by Degussa AG) [dibutyl phthalate (DBP) oil absorption=42 mL/100 mg, pH=9.5], and 500 parts of the amorphous polyester resin 1 were mixed in a HENSCHEL MIXER (manufactured by Nippon Coke & Engineering Co., Ltd.), and the mixture was kneaded for 30 minutes at 150° C. using two rolls. Then, the mixture was stretched and cooled, and pulverized with a pulverizer to obtain a pigment masterbatch 1.

### Preparation of Oil Phase

200 parts of the wax dispersion liquid 1, 750 parts of the amorphous polyester resin 1, and 100 parts of the pigment masterbatch 1 were put in the vessel and mixed by using a TK HOMOMIXER (manufactured by PRIMIX Corporation) at 5,000 rpm for 60 minutes to obtain an oil phase 1.

An oil phase 2 was prepared in the same manner as in the oil phase 1 except that the amount of the wax dispersion liquid 1 was changed to 190 parts and the amount of the amorphous polyester resin 1 was changed to 760 parts.

An oil phase 3 was prepared in the same manner as in the oil phase 1 except that the amount of the wax dispersion liquid 1 was changed to 210 parts and the amount of the amorphous polyester resin 1 was changed to 740 parts.

Table 1 indicates the blending rate of each component in the oil phase 1 to the oil phase 3.

The numerical value of the blending rate is “part.”

TABLE 1

| | AMORPHOUS | WAX | PIGMENT |
|---|---|---|---|
| | POLYESTER | DISPERSION | MASTERBATCH |
| | RESIN 1 | LIQUID 1 | 1 |
| OIL PHASE 1 | 750 | 200 | 100 |
| OIL PHASE 2 | 760 | 190 | 100 |
| OIL PHASE 3 | 740 | 210 | 100 |

### Preparation of Aqueous Phase

990 parts of water, 20 parts of sodium dodecyl sulfate, and 90 parts of ethyl acetate were mixed and stirred to obtain an aqueous phase 1.

### Emulsification

While 700 parts of the oil phase 1 was stirred by a TK HOMOMIXER at a revolution of 8,000 rpm, 20 parts of 28% ammonium water was added thereto. The mixture was mixed for 10 minutes, and then 1,200 parts of the aqueous phase 1 was gradually dropped to obtain an emulsion slurry 1.

An emulsion slurry 2 was prepared in the same manner as in the oil phase 1 except that the oil phase 1 was changed to the oil phase 2.

An emulsion slurry 3 was prepared in the same manner as in the oil phase 1 except that the oil phase 1 was changed to the oil phase 3.

### Solvent Removal

The emulsion slurry 1 was put into a vessel with a stirrer and a thermometer and was subjected to solvent removal for 180 minutes at 30° C. to obtain a desolvated slurry 1.

A desolvated slurry 2 was prepared in the same manner as in the desolvated slurry 1 except that the emulsion slurry 1 was changed to the emulsion slurry 2.

A desolvated slurry 3 was prepared in the same manner as in the desolvated slurry 1 except that the emulsion slurry 1 was changed to the emulsion slurry 3.

### Preparation of Shell Emulsion

### Production of Shell Resin 1

In a 5 L four-neck flask including a nitrogen introducing tube, a dewatering tube, a stirrer, and a thermocouple, 22 parts of ethylene glycol, 18 parts of glycerol, 80 parts of terephthalic acid, 99 parts of trimellitic anhydride, and 12.3 parts of sodium 5-sulfoisophthalate were contained. 1000 ppm of tetrabutyl orthotitanate (based on all the monomer content) as a condensation catalyst was put, and the mixture was heated to 230° C. for 2 hours under a nitrogen gas stream. Then, the mixture was reacted for 5 hours while distilling away the generated water. Then, the mixture was reacted for 4 hours at reduced pressures of 5 mmHg to 15 mmHg, and cooled to 180° C. to obtain a shell resin 1. The SP value was 10.8 (cal/cm³)^{1/2}.

### Production of Shell Resin 2

In a 5 L four-neck flask including a nitrogen introducing tube, a dewatering tube, a stirrer, and a thermocouple, 22 parts of ethylene glycol, 18 parts of glycerol, 80 parts of terephthalic acid, 99 parts of trimellitic anhydride, and 9.8 parts of sodium 5-sulfoisophthalate were contained. 1000 ppm of tetrabutyl orthotitanate (based on all the monomer content) as a condensation catalyst was put, and the mixture was heated to 230° C. for 2 hours under a nitrogen gas stream. Then, the mixture was reacted for 5 hours while distilling away the generated water. Then, the mixture was reacted for 4 hours at reduced pressures of 5 mmHg to 15 mmHg, and cooled to 180° C. to obtain a shell resin 2. The SP value was 10.5 (cal/cm³)^{1/2}.

Here, the SP value means a solubility parameter by the Fedors method and is a value δ obtained based on the following equation described in “Robert F. Fedors, Polymer Engineering and Science, 14, 147-154”.

$$δ = {( ΣΔ ei / ΣΔ vi )}^{1 / 2} \qquad Fedors Equation$$

Here, Δei is the evaporation energy (cal/mol) of an atom or an atomic group, and Δvi is a molar volume (cm³/mol).

### Preparation of Shell Emulsion

While 400 parts of solution liquid of the shell resin 1 was stirred by a TK HOMOMIXER at a revolution of 8,000 rpm, 5.9 parts of 28% ammonium water was added thereto so that the neutralization rate was 100%. The mixture was mixed for 10 minutes, and then 600 parts of the aqueous phase was gradually dropped to perform phase inversion emulsification of the shell resin 1.

Further, the resultant obtained by phase inversion emulsification of the shell resin 1 was desolvated by an evaporator to obtain a shell emulsion 1.

A shell emulsion 2 was prepared in the same manner as in the shell emulsion 1 except that phase inversion emulsification is performed on the shell resin 2 instead of the shell resin 1.

### Aggregation and Shell Formation Process

100 parts of the desolvated slurry 1 and 300 parts of ion-exchange water were put in the vessel and stirred for 1 minute.

Then, 100 parts of 3% magnesium chloride solution was dropped, and the mixture was stirred for 5 minutes and heated to 55° C. Then, when the particle diameter reached 5.0 μm, 18 parts of the shell emulsion 1 was added, and 15 parts of a 3% aqueous solution of magnesium chloride was further dropped. After stirring the mixture for 10 minutes, the mixture was heated to 65° C. and stirred for 30 minutes.

50 parts of sodium chloride was added, and the aggregation process was terminated to obtain an aggregated slurry 1.

### Fusion

The aggregated slurry 1 was heated to 70° C. while stirring, and when the desired average circularity of 0.957 was obtained, the mixture was cooled to obtain a dispersion slurry 1.

### Washing and Drying

After filtering 100 parts of the dispersion slurry 1 under reduced pressures, the following operations (1) to (4) were performed twice to obtain a filter cake 1.
(1) 100 parts of ion-exchange water were added to a filter cake and mixed using a TK HOMOMIXER (at a revolution of 12,000 rpm for 10 minutes), followed by filtration.
(2) 100 parts of a 10% aqueous solution of sodium hydroxide were added to the filter cake of (1) and mixed using a TK HOMOMIXER (at a revolution of 12,000 rpm for 30 minutes), followed by filtration under reduced pressures.
(3) 100 parts of 10% hydrochloric acid were added to the filter cake of (2) and mixed using a TK HOMOMIXER (at a revolution of 12,000 rpm for 10 minutes), followed by filtration.
(4) 300 parts of ion-exchange water were added to the filter cake of (3) and mixed using a TK HOMOMIXER (at a revolution of 12,000 rpm for 10 minutes), followed by filtration.

The filter cake 1 was dried by a circulating air dryer at 45° C. for 48 hours and then filtered with a mesh having an opening of 75 μm to obtain resin particles 1.

### External Additive Treatment Process

2.0 parts of hydrophobic silica (HDK-2000, manufactured by Clariant Ltd.) as an external additive was mixed with 100 parts of the resin particles 1 by a HENSCHEL MIXER, and the mixture was filtered with a mesh having an opening of 500 to obtain a toner 1.

Table 3 indicates physical properties of the resin particles.

Resin particles 2 to resin particles 7 were prepared in the same manner as in the resin particles 1 except that the types and the number of parts of the desolvated slurry and the shell emulsion to be added, and the heating temperatures in the aggregation and shell formation process and the fusion process were changed as indicated in Table 2.

Next, the resin particles 2 to the resin particles 7 were subjected to an external additive treatment in the same manner as in the resin particles 1 to obtain a toner 2 to a toner 7.

### Production of Resin Particles 8

### Emulsification and Solvent Removal

In the vessel containing the oil phase 1, 1,200 parts of the aqueous phase 1 were mixed using a TK HOMOMIXER at a revolution of 13,000 rpm for 20 minutes. Thus, an emulsion slurry 4 was prepared. The emulsion slurry 4 was put into a vessel with a stirrer and a thermometer and was subjected to solvent removal for 8 hours at 30° C. to obtain a desolvated slurry 4.

### Washing and Drying

After filtering 100 parts of the desolvated slurry 4 under reduced pressures, the following operations (1) to (4) were performed twice to obtain a filter cake 8.
(1) 100 parts of ion-exchange water were added to the filter cake and mixed using a TK HOMOMIXER (at a revolution of 12,000 rpm for 10 minutes), followed by filtration.
(2) 100 parts of a 10% aqueous solution of sodium hydroxide were added to the filter cake of (1) and mixed using a TK HOMOMIXER (at a revolution of 12,000 rpm for 30 minutes), followed by filtration under reduced pressures.
(3) 100 parts of 10% hydrochloric acid were added to the filter cake of (2) and mixed using a TK HOMOMIXER (at a revolution of 12,000 rpm for 10 minutes), followed by filtration.
(4) 300 parts of ion-exchange water were added to the filter cake of (3) and mixed using a TK HOMOMIXER (at a revolution of 12,000 rpm for 10 minutes), followed by filtration.

The filter cake 8 was dried by a circulating air dryer at 45° C. for 48 hours and then filtered with a mesh having an opening of 75 μm to obtain resin particles 8.

### External Additive Treatment Process

2.0 parts of hydrophobic silica (HDK-2000, manufactured by Clariant Ltd.) as an external additive was mixed with 100 parts of the resin particles 8 by a HENSCHEL MIXER, and the mixture was filtered with a mesh having an opening of 500 to obtain a toner 8.

### Production of Resin Particles 9

### Emulsification and Solvent Removal

In the vessel containing the oil phase 3, 1,200 parts of the aqueous phase 1 were mixed using a TK HOMOMIXER at a revolution of 13,000 rpm for 20 minutes. Thus, an emulsion slurry 5 was prepared.

The emulsion slurry 5 was put into a vessel with a stirrer and a thermometer and was subjected to solvent removal for 8 hours at 30° C. to obtain a desolvated slurry 5.

### Washing and Drying

After filtering 100 parts of the desolvated slurry 5 under reduced pressures, the following operations (1) to (4) were performed twice to obtain a filter cake 9.
(1) 100 parts of ion-exchange water were added to the filter cake and mixed using a TK HOMOMIXER (at a revolution of 12,000 rpm for 10 minutes), followed by filtration.
(2) 100 parts of a 10% aqueous solution of sodium hydroxide were added to the filter cake of (1) and mixed using a TK HOMOMIXER (at a revolution of 12,000 rpm for 30 minutes), followed by filtration under reduced pressures.
(3) 100 parts of 10% hydrochloric acid were added to the filter cake of (2) and mixed using a TK HOMOMIXER (at a revolution of 12,000 rpm for 10 minutes), followed by filtration.
(4) 300 parts of ion-exchange water were added to the filter cake of (3) and mixed using a TK HOMOMIXER (at a revolution of 12,000 rpm for 10 minutes), followed by filtration.

The filter cake 9 was dried by a circulating air dryer at 45° C. for 48 hours and then filtered with a mesh having an opening of 75 μm to obtain resin particles 9.

### External Additive Treatment Process

2.0 parts of hydrophobic silica (HDK-2000, manufactured by Clariant Ltd.) as an external additive was mixed with 100 parts of the resin particles 9 by a HENSCHEL MIXER, and the mixture was filtered with a mesh having an opening of 500 to obtain a toner 9.

By using these toners, low-temperature fixability and charge stability were evaluated.

Table 3 indicates the results.

### Evaluation Method

### Low-Temperature Fixability

The composite resin particles are uniformly placed on the paper surface at 0.8 mg/cm².

At this time, as a method of placing the powder on the paper surface, a printer from which a heat fixing machine is removed is used.

Other methods may be used as long as the powder can be uniformly placed at the above weight density.

The temperature at which cold offset occurred (MFT) was measured when the paper was passed through a pressure roller under conditions of a fixing speed (the circumferential speed of the heating roller) of 213 mm/see and a fixing pressure (the pressure of the pressure roller) of 10 kg/cm².

The lower the temperature at which cold offset occurs, the better the low-temperature fixability. A and B were accepted, and C and D were rejected.

### Evaluation Criteria for Cold Offset

Rank: fixing lower limit temperature
A: 130° C. or less
B: more than 130° C. and 135° C. or less
C: more than 135° C. and 140° C. or less
D: more than 140° C.

### Charge Stability

The developer was set in a modified machine of a commercially available digital full-color printer (IMAGIO Neo C455), and a running evaluation of 300,000 sheets was performed on an image chart having an image size of 50% in a monochrome mode. The charge stability was evaluated based on the evaluation criteria by the change amount in the charge amount of the carrier after the running.

The change amount in the charge amount was as follows.

That is, the humidity was controlled in an open system for 30 minutes or more in an environment (M/M environment) of a temperature of 23° C. and a relative humidity of 50%. After the initial carrier of 6.000 g and resin particles of 0.452 g were added to a stainless-steel vessel, the resultant was sealed. By the operation for 5 minutes at a scale of 150 using a shaker (YS-LD, manufactured by Yayoi Co., Ltd.), a friction-charged sample by shaking about 1,100 times was prepared.

The charge amount of the sample measured by a blow-off method (TB-200, manufactured by Toshiba Chemical Co., Ltd.) was defined as Q1, and, with regard to the carrier obtained by removing the resin particles in the developer after running by a blow-off device, the charge amount of the carrier measured in the same method was defined as Q2.

The absolute value (|Q1−Q2|) of the value obtained by subtracting the charge amount Q2 from the charge amount Q1 was used as the change amount in the charge amount.

### Evaluation Criteria

A: the change amount in the charge amount is less than 10 μc/g.
B: the change amount in the charge amount is 10 μc/g or more and less than 15 μc/g.
C: the change amount in the charge amount is 15 μc/g or more and less than 20 μc/g.
D: the change amount in the charge amount is 20 μc/g or more.

TABLE 2

| | | EXAMPLE AND COMPARATIVE EXAMPLE NO. | | | | |
|---|---|---|---|---|---|---|
| | | EXAMPLE 1 | EXAMPLE 2 | EXAMPLE 3 | EXAMPLE 4 | EXAMPLE 5 |
| | | RESIN PARTICLES NO. | | | | |
| | | RESIN | RESIN | RESIN | RESIN | RESIN |
| | | PARTICLES 1 | PARTICLES 2 | PARTICLES 3 | PARTICLES 4 | PARTICLES 5 |
| CORE | DESOLVATED | DESOLVATED | DESOLVATED | DESOLVATED | DESOLVATED | DESOLVATED |
| RESIN | SLURRY NO. | SLURRY 1 | SLURRY 2 | SLURRY 3 | SLURRY 1 | SLURRY 2 |
| | | (DERIVED | (DERIVED | (DERIVED | (DERIVED | (DERIVED |
| | | FROM OIL | FROM OIL | FROM OIL | FROM OIL | FROM OIL |
| | | PHASE 1) | PHASE 2) | PHASE 3) | PHASE 1) | PHASE 2) |
| | BLENDING PARTS | 100 | 90 | 100 | 100 | 90 |
| | (SOLID CONTENT | | | | | |
| | CONVERTED) | | | | | |
| | PET (SOLID | 20 | 10 | 10 | 5 | 5 |
| | CONTENT RATE) | | | | | |
| SHELL | SHELL | SHELL | SHELL | SHELL | SHELL | SHELL |
| RESIN | EMULSION NO. | EMULSION 1 | EMULSION 1 | EMULSION 1 | EMULSION 2 | EMULSION 2 |
| | BLENDING PARTS | 18 | 18 | 18 | 15 | 15 |
| | (SOLID CONTENT | | | | | |
| | CONVERTED) | | | | | |
| PROCESS | AGGREGATION | 65 | 67 | 63 | 65 | 67 |
| TEMPER- | TEMPERATURE | | | | | |
| ATURE | (° C.) | | | | | |
| | FUSION | 70 | 72 | 68 | 70 | 72 |
| | TEMPERATURE | | | | | |
| | (° C.) | | | | | |

| | | EXAMPLE AND COMPARATIVE EXAMPLE NO. | | | |
|---|---|---|---|---|---|
| | | | COMPARATIVE | COMPARATIVE | COMPARATIVE |
| | | EXAMPLE 6 | EXAMPLE 1 | EXAMPLE 2 | EXAMPLE 3 |
| | | RESIN PARTICLES NO. | | | |
| | | RESIN | RESIN | RESIN | RESIN |
| | | PARTICLES 6 | PARTICLES 7 | PARTICLES 8 | PARTICLES 9 |
| CORE | DESOLVATED | DESOLVATED | DESOLVATED | DESOLVATED | DESOLVATED |
| RESIN | SLURRY NO. | SLURRY 3 | SLURRY 1 | SLURRY 4 | SLURRY 5 |
| | | (DERIVED | (DERIVED | (DERIVED | (DERIVED |
| | | FROM OIL | FROM OIL | FROM OIL | FROM OIL |
| | | PHASE 3) | PHASE 1) | PHASE 1) | PHASE 3) |
| | BLENDING PARTS | 100 | 100 | — | — |
| | (SOLID CONTENT | | | | |
| | CONVERTED) | | | | |
| | PET (SOLID | 5 | 10 | 0 | 180 |
| | CONTENT RATE) | | | | |
| SHELL | SHELL | SHELL | NO SHELL | NO SHELL | NO SHELL |
| RESIN | EMULSION NO. | EMULSION 2 | | | |
| | BLENDING PARTS | 15 | — | — | — |
| | (SOLID CONTENT | | | | |
| | CONVERTED) | | | | |
| PROCESS | AGGREGATION | 63 | 65 | — | — |
| TEMPER- | TEMPERATURE | | | | |
| ATURE | (° C.) | | | | |
| | FUSION | 68 | 70 | — | — |
| | TEMPERATURE | | | | |
| | (° C.) | | | | |

TABLE 3

| | | EXAMPLE AND COMPARATIVE EXAMPLE NO. | | | | | | | | |
|---|---|---|---|---|---|---|---|---|---|---|
| | | | | | | | | COMPAR- | COMPAR- | COMPAR- |
| | | | | | | | | ATIVE | ATIVE | ATIVE |
| | | EXAM- | EXAM- | EXAM- | EXAM- | EXAM- | EXAM- | EXAM- | EXAM- | EXAM- |
| | | PLE 1 | PLE 2 | PLE 3 | PLE 4 | PLE 5 | PLE 6 | PLE 1 | PLE 2 | PLE 3 |
| | | RESIN PARTICLES NO. | | | | | | | | |
| | | RESIN | RESIN | RESIN | RESIN | RESIN | RESIN | RESIN | RESIN | RESIN |
| | | PARTI- | PARTI- | PARTI- | PARTI- | PARTI- | PARTI- | PARTI- | PARTI- | PARTI- |
| | | CLES 1 | CLES 2 | CLES 3 | CLES 4 | CLES 5 | CLES 6 | CLES 7 | CLES 8 | CLES 9 |
| ANALYSIS | I(0) | 0.023 | 0.021 | 0.025 | 0.018 | 0.017 | 0.019 | 0.003 | 0.010 | 0.003 |
| VALUE | I(20) | 0.015 | 0.008 | 0.018 | 0.014 | 0.010 | 0.017 | 0.006 | 0.005 | 0.005 |
| | I(100) | 0.006 | 0.005 | 0.016 | 0.010 | 0.007 | 0.015 | 0.008 | 0.003 | 0.003 |
| EVALU- | CHARGE | A | B | A | B | B | B | D | C | D |
| ATION | STABILITY | | | | | | | | | |
| | LOW- | A | B | B | A | A | B | C | D | D |
| | TEMPERATURE | | | | | | | | | |
| | FIXABILITY | | | | | | | | | |

Aspects of the present disclosure are, for example, as follows.

According to a first aspect, a resin particle having a core-shell structure includes a binder resin and an organic compound having a sulfo group, and the following formulas (1) and (2) are satisfied in a range of 0<t<100:

$$I ( 100 ) < I ( t ) < I ( 0 ) \qquad Formula ( 1 )$$

$$0.005 < I ( 100 ) \qquad Formula ( 2 )$$

where I(t) represents, in a depth profile of a surface of the resin particle measured by time-of-flight secondary ion mass spectrometry, a secondary ion intensity derived from the sulfo group at t (nm) in depth from an outermost surface of the resin particle.

According to a second aspect, in the resin particle of the first aspect, the following formula (3) is satisfied:

$$I ( 100 ) < I ( 20 ) . \qquad Formula ( 3 )$$

According to a third aspect, in the resin particle of the first aspect or the second aspect, the binder resin comprises a recycle-derived resin or a biomass-derived resin.

According to a fourth aspect, in the resin particle of the third aspect, the recycle-derived resin comprises at least one of polyethylene terephthalate (PET) or polybutylene terephthalate (PBT).

According to a fifth aspect, in the resin particle of any one of the first aspect to the fourth aspect, the resin particle is produced by an emulsion polymerization aggregation method.

According to a sixth aspect, the resin particle of any one of the first aspect to the fifth aspect further include a colorant and a releasing agent.

According to a seventh aspect, a toner includes the resin particle of any one of the first aspect to the sixth aspect and an external additive added to the resin particle.

According to an eighth aspect, a toner containing unit contains the toner of the seventh aspect.

According to a ninth aspect, a developer includes the toner of the seventh aspect and a carrier.

According to a tenth aspect, an image forming apparatus includes an electrostatic latent image bearer, an electrostatic latent image forming unit to form an electrostatic latent image on the electrostatic latent image bearer, and a developing unit including the toner of the seventh aspect, to develop the electrostatic latent image formed on the electrostatic latent image bearer and form a visible image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A resin particle having a core-shell structure comprising:
a binder resin; and
an organic compound having a sulfo group,
wherein the following formulas (1) and (2) are satisfied in a range of 0<t<100:
$$I ( 100 ) < I ( t ) < I ( 0 ) \qquad Formula ( 1 )$$
$$0.005 < I ( 100 ) \qquad Formula ( 2 )$$
where I(t) represents, in a depth profile of a surface of the resin particle measured by time-of-flight secondary ion mass spectrometry, a secondary ion intensity derived from the sulfo group at t (nm) in depth from an outermost surface of the resin particle.

2. The resin particle according to claim 1, wherein the following formula (3) is satisfied:
$$I ( 100 ) < I ( 20 ) . \qquad Formula ( 3 )$$

3. The resin particle according to claim 1, wherein the binder resin comprises a recycle-derived resin or a biomass-derived resin.

4. The resin particle according to claim 3, wherein the recycle-derived resin comprises at least one of polyethylene terephthalate or polybutylene terephthalate.

5. The resin particle according to claim 1, wherein the resin particle is produced by an emulsion polymerization aggregation method.

6. The resin particle according to claim 1, further comprising a colorant and a releasing agent.

7. A toner comprising:
the resin particle according to claim 6; and
an external additive added to the resin particle.

8. A toner containing unit containing the toner according to claim 7.

9. A developer comprising the toner according to claim 7 and a carrier.

10. An image forming apparatus comprising:
an electrostatic latent image bearer;
an electrostatic latent image forming unit to form an electrostatic latent image on the electrostatic latent image bearer; and
a developing unit including the toner according to claim 7, to develop the electrostatic latent image formed on the electrostatic latent image bearer and form a visible image.
